(19) United States
(12) Patent Application Publication
(10) Pub. No.: US 2006/0029456 A1
(43) Pub. Date: Feb. 9, 2006

(54) Container for cosmetics

(76) Inventor: Ming Hsiung Liu, Chang Hua Hsien (TW)

Correspondence Address: LEONG C LEI, PMB # 1008, 1867 YGNACIO VALLEY ROAD, WALNUT CREEK, CA, 94598, US

(21) Appl. No.: 10/913,353

(22) Filed: Aug. 9, 2004

(51) Int. Cl. B43K 5/16; B43K 5/06

(52) U.S. Cl. 401/108; 401/107

(57) ABSTRACT

A cosmetic container is disclosed. The container structure comprises an upper housing having a top end being a through hole; a driving device positioned within the housing and having a rotating knob at the bottom section protruded beneath the housing; two fan-like caps mounted to the bottom section of the through hole and being driven to open or close by the driving device; a holding seat having a top section in engagement with rod-shaped cosmetics or the like, which is elevated or retracted by the driving device to open or close the two fan-like caps; and a lower housing mounted onto the rotating knob which interlinked to the rotating knob.

### BACKGROUND OF THE INVENTION

(a) Technical Field of the Invention

The present invention is related to container and in particular relates to cosmetic container for fully enclose the rod-shape cosmetic within the container.

(b) Description of the Prior Art

Taiwan Patent Publication No. 270306 and No. 377575 disclose a cosmetic container having an upper housing containing a driving device and a holding seat. A cap body is used to cap the cosmetic when the cosmetic is fully retracted into the container. The drawback of such container is that the cap is detachable from the container and if the cap is missing, the cosmetic cannot be properly capped and the cosmetic is not usable.

### SUMMARY OF THE INVENTION

An object of the present invention is to provide a cosmetic or the like container structure comprising an upper housing having a top end being a through hole; a driving device positioned within the housing and having a rotating knob at the bottom section protruded beneath the housing; two fan-like caps mounted to the bottom section of the through hole and being driven to open or close by the driving device; a holding seat having a top section in engagement with rod-shaped cosmetics or the like, which is elevated or retracted by the driving device to open or close the two fan-like caps; and a lower housing mounted onto the rotating knob which interlinked to the rotating knob.

Yet another object of the present invention is to provide a cosmetic or the like container structure comprising an upper housing having a top end being a through hole; a driving device positioned within the housing and having a rotating knob at the bottom section protruded beneath the housing; two fan-like caps mounted to the bottom section of the through hole and being driven to open or close by the driving device; a holding seat having a top section in engagement with rod-shaped cosmetics or the like, which is elevated or retracted by the driving device to open or close the two fan-like caps; a lower housing having a cavity with an upward opening which is mounted onto the rotating knob to interlink with the rotating knob and the cavity contained a vibrator and a battery supplying power to the vibrator.

Still another object of the present invention is to provide a container for cosmetic, wherein the driving device comprises a securing mount secured to the interior of the upper housing and having a bottom end portion protruded out from the underneath of the upper housing and having an inner wall being provided with two spiral slots; an inner mounting tube positioned within the securing mount and having a top end protruded out the top of the securing mount and being mounted with an arch-shaped seat plate, and the tube wall of the inner mounting tube being two perpendicular slots and the bottom end of the perpendicular slot being extended to a spiral section corresponding to the spiral slots, and the seat plate being provided with two slanting slots having a top end being a horizontal positioning section; a driving shaft mounted within the inner mounting tube and having a top end being a spherical pivotal section, and the external diameter of the pivotal section being smaller than the internal diameter of the seat plate, and the bottom end of the driving shaft being protruded beneath the inner mounting tube and having a rotating knob, and the inner section of the driving shaft being a cavity to the top end of the driving shaft, and the wall of the shaft being provided with two upright slots having a bottom end being horizontally extended to form a horizontal section, and the circumferential edge of the pivotal section being provided with two corresponding slots; the two fan-like caps within the two sides of the wall of the cap are provided with a protruded rib for smooth engagement with the circular slot, and the external circumferential edge of the cap is protruded with a protrusion extended to the slanting slot of the seat plate; the holding seat moveable along the cavity of the driving shaft upward and downward and having a top section mounted with a holding slot for the engagement with rod-like or rod-shaped cosmetics, and the circumferential edge of the holding seat being protruded with two sliding protrusions passed through the upright slot and the vertical slot, and being extended to the spiral slot.

Yet another object of the present invention is to provide a vibration mechanism, wherein the protruded spherical surface of the container is used to massage blood point of the human body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a preferred embodiment of the present invention.

FIG. 2 is a perspective view of a preferred embodiment of the present invention.

FIG. 3 is a sectional view of a preferred embodiment of the present invention.

FIGS. 4-7B show the action of the container in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

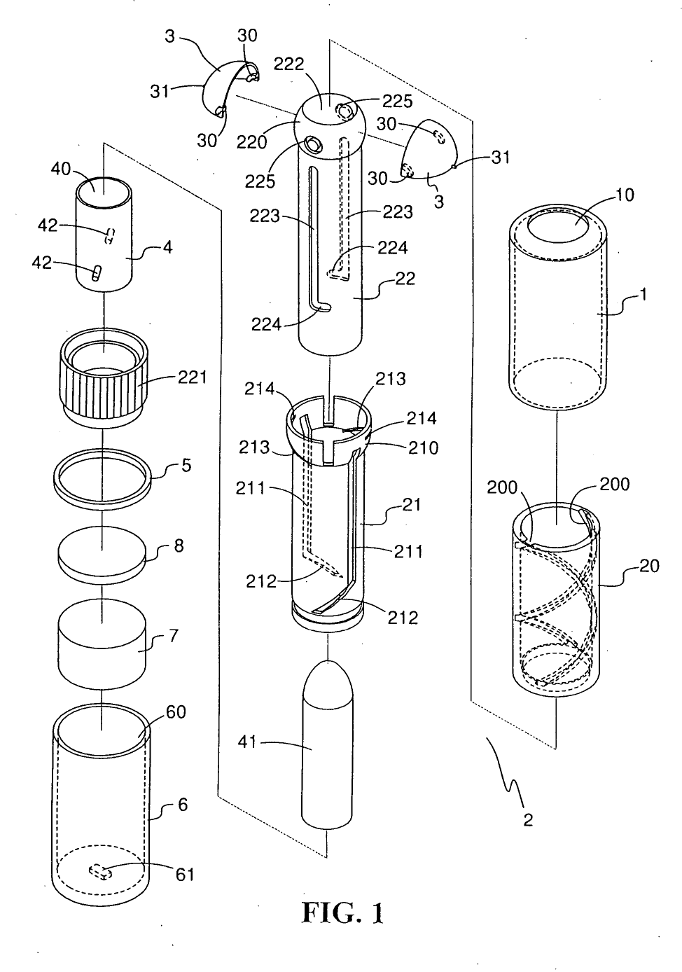

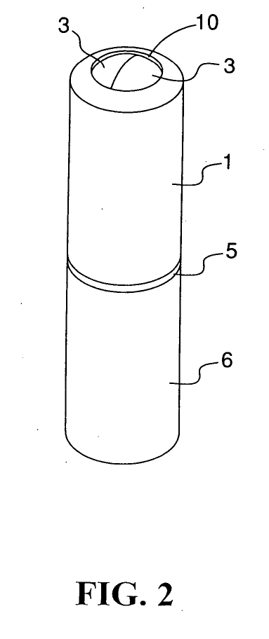

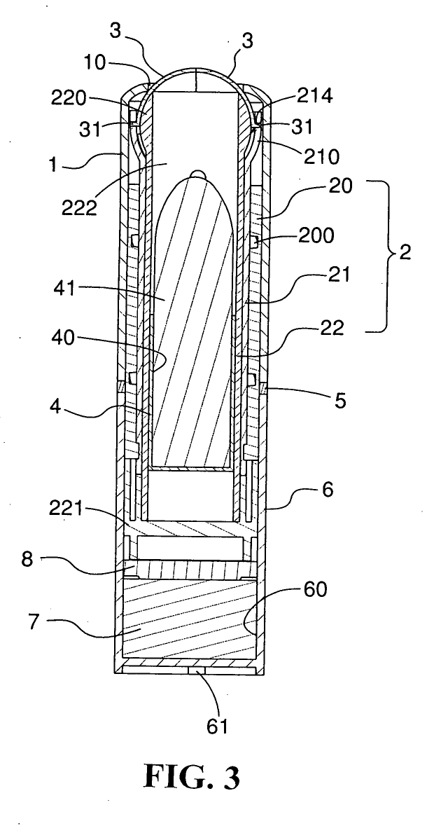

Referring to FIGS. 1 to 3, there is shown a cosmetic or the like container structure comprising an upper housing 1 having a top end being provided with a through hole 10; a driving device 2 containing a securing mount 20, an inner mounting tube 21 and a driving shaft 22 wherein the securing mount 20 is secured to the interior of the upper housing 1 and has a bottom end portion protruded out from the underneath of the upper housing 1 and has an inner wall being provided with two spiral slots 200; two fan-like caps 3 mounted to the bottom section of the through hole 10 and are driven to open or close by the driving device 3; and the two fan-like caps 3 within the two sides of the wall of the cap 3 are provided with a protruded rib 30 for smooth engagement with the circular slot 225, and the external circumferential edge of the cap 3 is protruded with a protrusion 31 extended to the slanting slot 213 of the seat plate 210; the holding seat 4 is moveable along the cavity 222 of the driving shaft 22 upward and downward and has a top section mounted with a holding slot 40 for the engagement with rod-like or rod-shaped cosmetics 41, and the circumferential slot 40 is protruded with two sliding protrusions 42 passed through the upright slot 233 and the perpendicular slot 211, and is extended to the spiral slot 200, an ornamental mount 5 is mounted at the securing mount 20 provided on the underneath of the upper housing 1, the lower housing 6 has a cavity 60 with an upward opening which is mounted onto the rotating knob 221 to interlink with the rotating knob 221 and the cavity 60 contains a vibrator 7 and a battery 8 supplying power to the vibrator 7, wherein the securing mount 20 is secured to the interior of the upper housing 1 and has a bottom end portion protruded out from the underneath of the upper housing 1 and has an inner wall being provided with two spiral slots 200; the inner mounting tube 21 is positioned within the securing mount 20 and has a top end protruded out the top of the securing mount 20 and is mounted with an arch-shaped seat plate 21, and the tube wall of the inner mounting tube 21 has two perpendicular slots 211 and the bottom end of the perpendicular slot 211 is extended to a spiral section 212 corresponding to the spiral slots 200, and the seat plate 210 is provided with two slanting slots 213 having a top end being a horizontal positioning section 214; the driving shaft 22 is mounted within the inner mounting tube 21 and has a top end being a spherical pivotal section 220, and the external diameter of the pivotal section 220 is smaller than the internal diameter of the seat plate 210, and the bottom end of the driving shaft 22 is protruded beneath the inner mounting tube 21 and has a rotating knob 221, and the inner section of the driving shaft 22 is a cavity 222 to the top end of the driving shaft 22, and the wall of the shaft 22 is provided with two upright slots 223 having a bottom end being horizontally extended to form a horizontal section 224, and the circumferential edge of the pivotal section 220 is provided with two corresponding slots 225; two fan-like caps 3 mounted to the bottom section of the through hole 10 and are driven to open or close by the driving device 2; the two fan-like caps 3 within the two sides of the wall of the cap 3 are provided with a protruded rib 30 for smooth engagement with the circular slot 225, and the external circumferential edge of the cap 3 is protruded with a protrusion 31 extended to the slanting slot 213 of the seat plate 210; the holding seat 4 is moveable along the cavity 222 of the driving shaft 22 upward and downward and has a top section mounted with a holding slot 40 for the engagement with rod-like or rod-shaped cosmetics 41, and the circumferential edge of the holding slot 41 is protruded with two sliding protrusions 42 passed through the upright slot 233 and the perpendicular slot 211, and is extended to the spiral slot 200; an ornamental mount 5 is mounted at the securing mount 20 provided on the underneath of the upper housing 1, the vibrator 7 is provided at the cavity 60 of the lower housing 6 and is ON or OFF by means of a switch 61; the battery 8 is positioned within the cavity 60 to provide power to the vibrator.

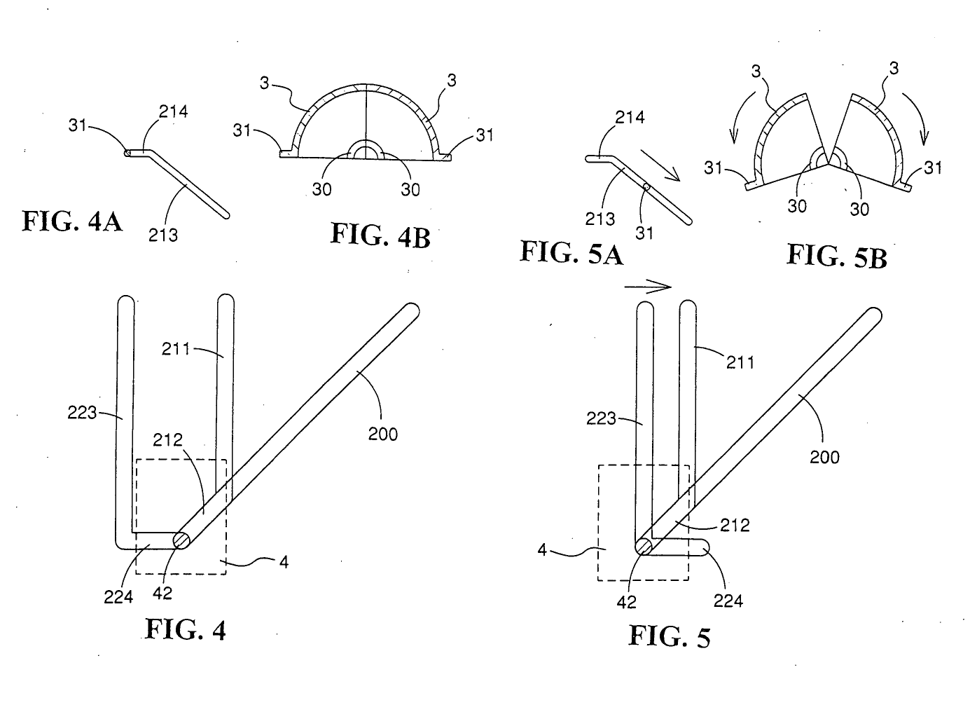

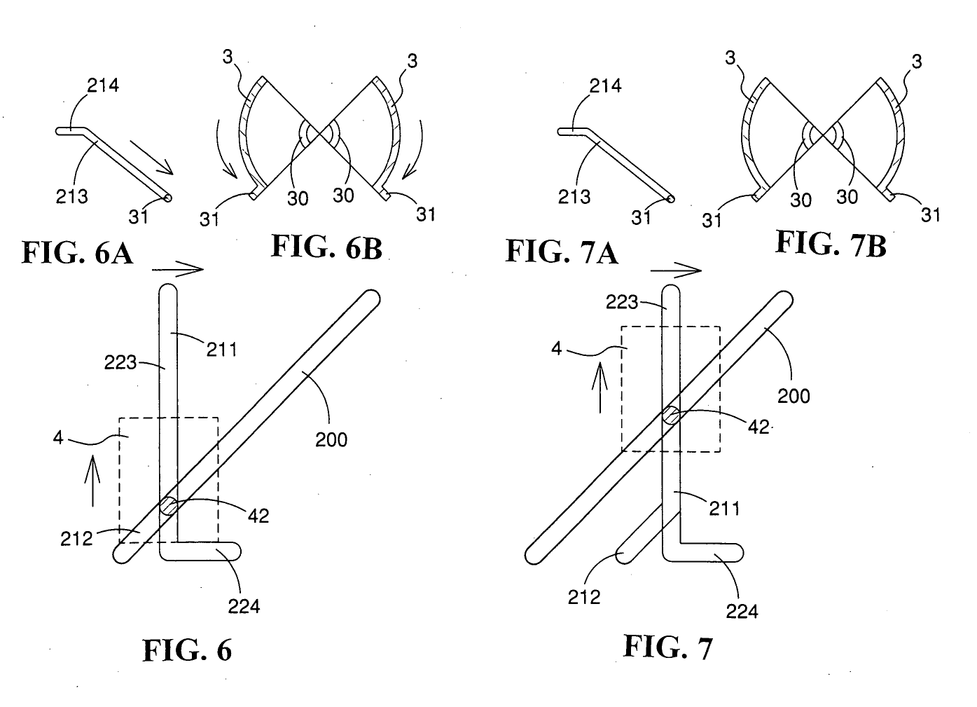

Referring to FIGS. 4, 4A and 4B, there is shown the fan-like caps 3 are closed and the holding seat 4 is at the lowest position. The sliding protrusion 42 of the holding seat 4 is positioned at the end portion of the horizontal section 224, the bottom end of the spiral section 212 and the bottom end of the spiral slot 200, and the protrusion 31 of the fan-like cap 3 is positioned at the securing section 214.

Referring to FIGS. 1, 5, 5A and 5B, when the lower housing 6 is rotated, the rotating knob 221 interlinks with the driving shaft 22 to rotate clockwise, and the position of the sliding protrusion is at the bottom section of the upright slot 223, the inner mounting tube 21 and the holding seat 4 will not rotate, and only the driving shaft 22 rotates clockwise, i.e., the holding seat 4 will not move, and the two fan-like cap 3 is slid to the rim slot 225 as a result of the rib 30, and therefore the driving shaft 22 will rotate clockwise. When the fan-like cap 3 rotates clockwise, the protrusion 31 will move along the slanting slot 213 to the center region of the slanting slot 213. Thus the fan-like cap 3 will move an angle about the center of the rim slot 225 and the two fan-like caps 3 open into a small hole.

As shown in FIGS. 1,6, 6A and 6B, when the driving shaft 22 continuous to rotate clockwise until the upright slot 223 and the perpendicular slot 211 are superimposed, the fan-shaped cap 3 will rotate clockwise together with the driving shaft 22 such that the protrusion 31 will slide to the bottom end along the slanting slot 213 such that the two fan-shaped caps 3 open an opening similar to the size of the through hole 10 (fully open). At the same time, the sliding protrusion 42 is driven by the spiral section 212 until the intersection of the perpendicular slot 211 and the spiral section 212, and the sliding protrusion 42 is positioned at the upright slot 223 as a result of the spiral section 212 (and the height is the difference of the two ends of the spiral section). Thus, the holding seat 4 drives the rod-like cosmetics 41 to a certain height.

As shown in FIGS. 1, 7, 7A and 7B, when the driving shaft 22 continuous to rotate the upright slot 223 and the perpendicular slot 211 will be passed through by the sliding protrusion 42, and the inner mounting tube 21 will rotate in accordance with the rotating shaft 22. Thus the fan-shaped cap 3 will not continuous to open. At the same time the sliding protrusion 42 is positioned at the perpendicular slot 211 and the upright slot 223 as a result of the driving of the spiral slot 200, and the sliding protrusion 42 is moved upward. Thus, the holding seat 4 will drive the cosmetics 41 upward.

When the lower housing 6 rotates counter clockwise, the action is the reverse of the above and the cosmetics 41 move downward, and the two fan-shaped caps 3 are closed.

In accordance with the present invention the advantages are as follows:
The cosmetics will be enclosed and the lost of cap shall not be happened.
The vibrator allows even application of cosmetic.
The spherical shape of the cap provides a tool for massaging to pressure point on the human body.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cosmetic container or the like container structure comprising
an upper housing having a top end being a through hole;
a driving device positioned within the housing and having a rotating knob at the bottom section protruded beneath the housing;
two fan-like caps mounted to the bottom section of the through hole and being driven to open or close by the driving device;
a holding seat having a top section in engagement with rod-shaped cosmetics or the like, which is elevated or retracted by the driving device to open or close the two fan-like caps; and
a lower housing mounted onto the rotating knob which interlinked to the rotating knob.

2. A cosmetic container or the like container structure comprising
an upper housing having a top end being a through hole;
a driving device positioned within the housing and having a rotating knob at the bottom section protruded beneath the housing;
two fan-like caps mounted to the bottom section of the through hole and being driven to open or close by the driving device;
a holding seat having a top section in engagement with rod-shaped cosmetics or the like, which is elevated or retracted by the driving device to open or close the two fan-like caps;
a lower housing having a cavity with an upward opening which is mounted onto the rotating knob to interlink with the rotating knob and the cavity contained a vibrator and a battery supplying power to the vibrator.

3. The cosmetic container of claim 1, wherein the two fan-like caps close with each other to form a spherical shape and the top section of the spherical shaped cap is exposed at the external of the through hole.

4. The cosmetic container of claim 1, wherein the driving device comprises
a securing mount secured to the interior of the upper housing and having a bottom end portion protruded out from the underneath of the upper housing and having an inner wall being provided with two spiral slots;
an inner mounting tube positioned within the securing mount and having a top end protruded out the top of the securing mount and being mounted with an arch-shaped seat plate, and the tube wall of the inner mounting tube being two perpendicular slots and the bottom end of the perpendicular slot being extended to a spiral section corresponding to the spiral slots, and the seat plate being provided with two slanting slots having a top end being a horizontal positioning section;
a driving shaft mounted within the inner mounting tube and having a top end being a spherical pivotal section, and the external diameter of the pivotal section being smaller than the internal diameter of the seat plate, and the bottom end of the driving shaft being protruded beneath the inner mounting tube and having a rotating knob, and the inner section of the driving shaft being a cavity to the top end of the driving shaft, and the wall of the shaft being provided with two upright slots having a bottom end being horizontally extended to form a horizontal section, and the circumferential edge of the pivotal section being provided with two corresponding slots;
the two fan-like caps within the two sides of the wall of the cap are provided with a protruded rib for smooth engagement with the circular slot, and the external circumferential edge of the cap is protruded with a protrusion extended to the slanting slot of the seat plate;
the holding seat moveable along the cavity of the driving shaft upward and downward and having a top section mounted with a holding slot for the engagement with rod-like or rod-shaped cosmetics, and the circumferential edge of the holding seat being protruded with two sliding protrusions passed through the upright slot and the vertical slot, and being extended to the spiral slot.

5. The cosmetic container of claim 1, further comprising an ornamental mount mounted at the securing mount provided on the underneath of the upper housing.

6. The cosmetic container of claim 2, wherein the lower housing is a switch for controlling the vibrator.
